(19) United States
(12) Patent Application Publication
(10) Pub. No.: US 2014/0307994 A1
(43) Pub. Date: Oct. 16, 2014

(54) ELECTRO-OPTIC MODULATOR HAVING LARGE BANDWIDTH

(71) Applicant: HON HAI PRECISION INDUSTRY CO., LTD., New Taipei (TW)

(72) Inventor: HSIN-SHUN HUANG, New Taipei (TW)

(73) Assignee: HON HAI PRECISION INDUSTRY CO., LTD., New Taipei (TW)

(21) Appl. No.: 14/067,956

(22) Filed: Oct. 31, 2013

(30) Foreign Application Priority Data
Apr. 10, 2013 (TW) 102112605

(51) Int. Cl. G02F 1/225

(52) U.S. Cl. CPC G02F 1/225
USPC 385/2

(57) ABSTRACT

An electro-optic modulator includes a substrate, a waveguide lens, a waveguide, and electrodes. The waveguide lens and the waveguide are formed inside the substrate. The waveguide connects the waveguide lens and includes a first branch and a second branch. The electrodes are configured to modulate outputs of the waveguide lens and the waveguide.

### BACKGROUND

1. Technical Field

The present disclosure relates to integrated optics, and more particularly to an electro-optic modulator having a wider bandwidth.

2. Description of Related Art

Electro-optic modulators are used in integrated optics to carry and transmit information. However, with the rapid development of information technology, bandwidths of the electro-optic modulators are often narrower than satisfactory.

Therefore, it is desirable to provide an electro-optic modulator that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of an electro-optic modulator, according to an embodiment.

FIG. 2 is a cross-sectional view taken along a line II-II of FIG. 1.

FIG. 3 is a schematic view of a media grating of the electro-optic modulator of FIG. 1.

FIG. 4 is a cross-sectional view taken along a line IV-IV of FIG. 1.

### DETAILED DESCRIPTION

Embodiments of the present disclosure will be described with reference to the drawings.

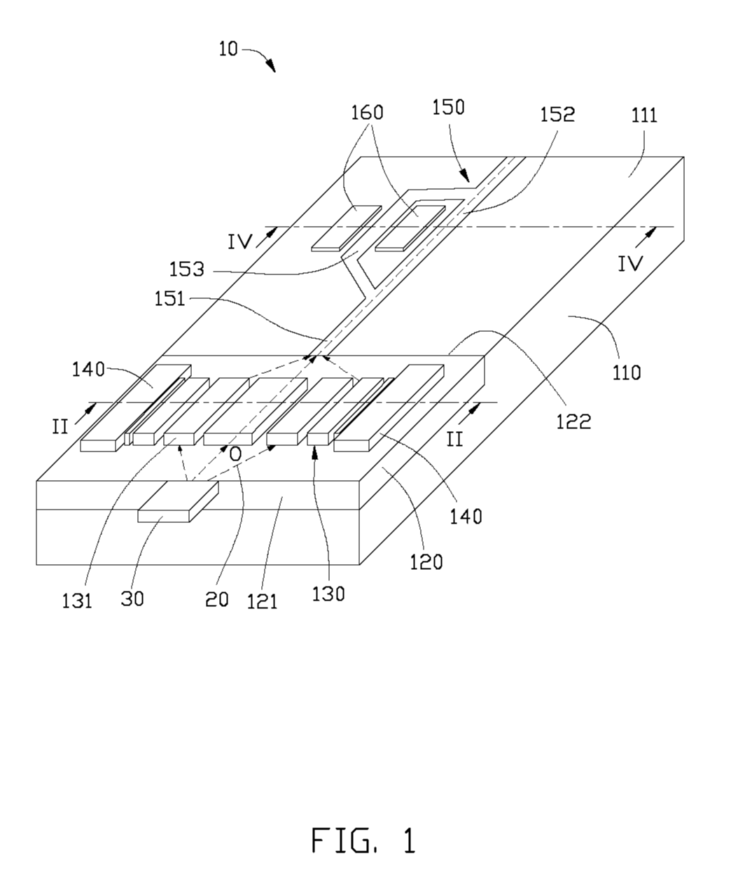

FIG. 1 shows an electro-optic modulator 10, according to an embodiment. The modulator 10 includes a substrate 110, a planar waveguide 120, a media grating 130, a pair of first electrodes 140, a waveguide 150, and a pair of second electrodes 160.

The planar waveguide 120 is formed inside the substrate 110 and includes a sidewall 121 and an interface 122 opposite to the sidewall 121. The sidewall 121 receives a laser beam 20 incident thereon and transmits the laser beam along an optical axis O. In this embodiment, the laser beam 20 is emitted by a laser light source 30 attached to the sidewall 121 by a die bond technology. The laser light source 30 is a distributed feedback laser (DFB). In other embodiments, the laser light source 30 can be changed as needed.

The media grating 130 is formed on the planar waveguide 120 and is symmetrical about the optical axis O. According to the theory of integrated optics, effective indexes of parts of the planar waveguide 120 loaded with the media gratings 130 increase. As such, by properly constructing the media grating 130, the media grating 130 and the planar waveguide 120 can constitute and function as a diffractive waveguide lens to converge the laser beam 20.

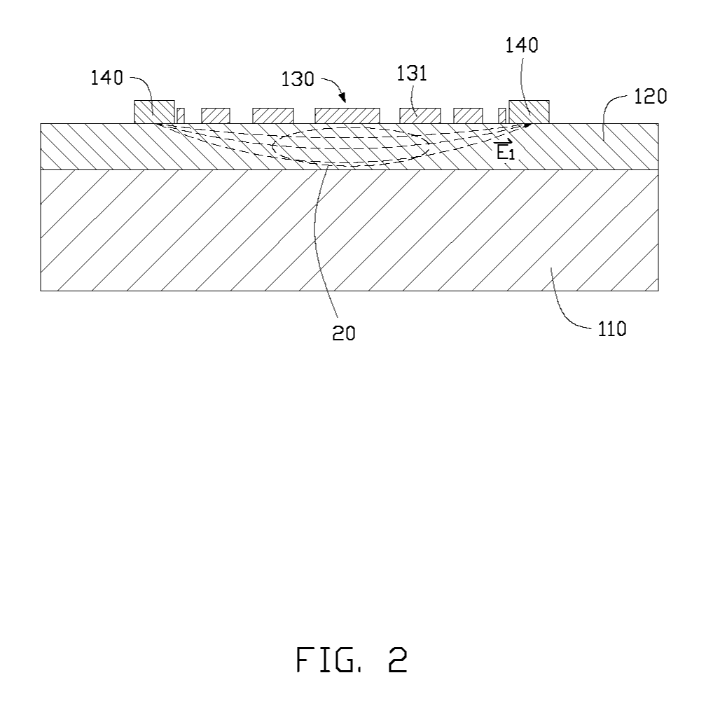

The first electrodes 140 are positioned on the planar waveguide 120 at two opposite sides of the media grating 130 and are symmetrical about the optical axis O. The first electrodes 140 receive a first modulating voltage from a control circuit (not shown) and generate a first modulating electric field E̅₁̅ (see FIG. 2). The first modulating electric field E̅₁̅ changes, utilizing the electro-optic effect, an effective refractive index of the planar waveguide 13 thus changes an effective focal length of the waveguide lens. Thus, a convergence level of the laser beam 20 can be modulated, thereby modulating a portion of the laser beam 20 entering the waveguide 150, i.e., an output power of the waveguide lens can be modulated by the first electrodes 140. Therefore, transmitted information can be modulated to the output power of the waveguide lens.

The waveguide 150 is formed on the substrate 110 and includes an input section 151 coupled to the interface 122 and extending along the optical axis O. The waveguide 150 includes a first branch 152 and a second branch 153.

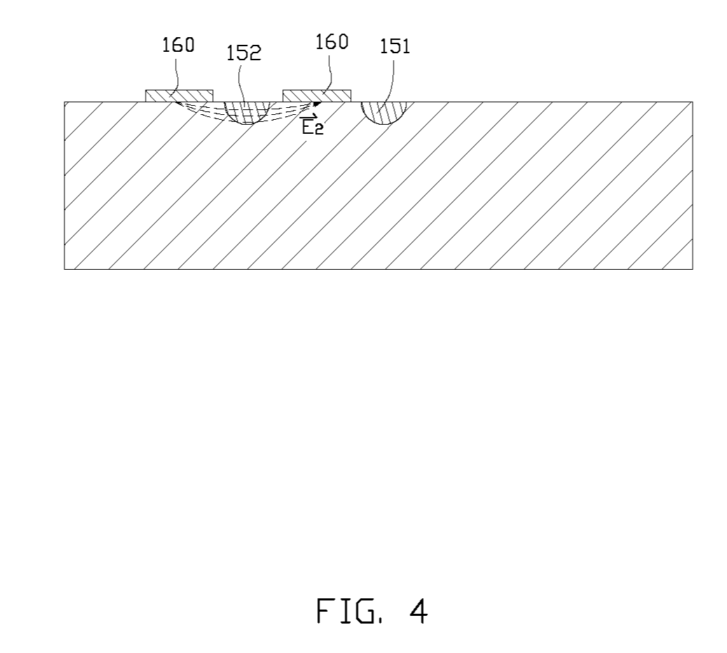

The second electrodes 160 are positioned on the substrate 110 at two opposite sides of the second branch 153. The second electrodes 160 receive a second modulating voltage from the control circuit and generate a second modulating electric field E̅₂̅ (see FIG. 4). The second modulating electric field E̅₂̅ changes an effective refractive index of the second branch 153. As such, as lightwaves traverse the first branch 152 and the second branch 153, a phase shift and interference level between the first branch 152 and the second branch 153 can be modulated. Thus, an output power of the waveguide 150 can be modulated by the second electrodes 160. Therefore, additional information can be modulated to the output power of the waveguide 150.

As described, transmitted information can be modulated to both the waveguide lens and the waveguide 150. As such, a bandwidth of the electro-optic modulator 10 is widened.

The substrate 110 is made of lithium niobate crystal to increase a bandwidth of the modulator 10, as the lithium niobate crystal has a high response speed. In this embodiment, the substrate 110 is substantially rectangular and includes a top surface 111 substantially perpendicular to the sidewall 122. In other embodiments, the substrate 110 can be made of other suitable materials.

The planar waveguide 120 is substantially rectangular and is made by infusing titanium into the top surface 111. The refractive index of the planar waveguide 120 gradually changes along a widthwise direction thereof due to material characteristics of the planar waveguide 120 and the media grating 130.

The media grating 130 can be made of lithium niobate crystal infused with titanium or be a high refractive film.

In this embodiment, the media grating 130 is a chirped grating and has an odd number of media strips 131. The media strips 131 are symmetrical about the optical axis O. The media strips 131 are rectangular and parallel with each other. In order from the optical axis O to each side, widths of the media strips 131 decrease, and widths of gaps between each two adjacent media strips 131 also decrease.

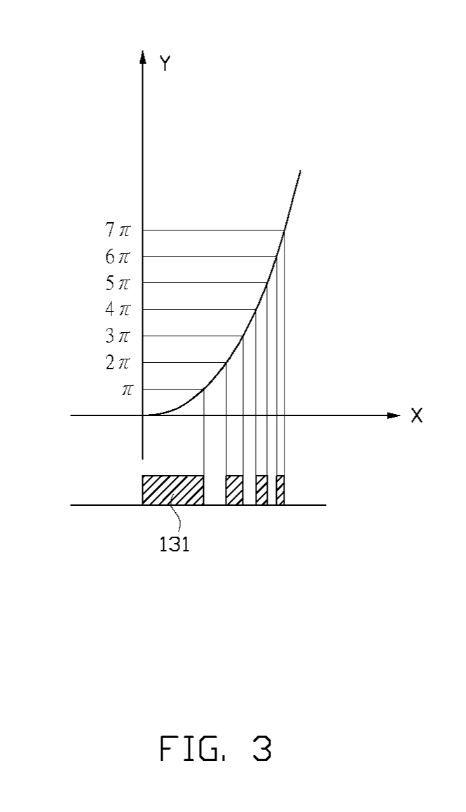

FIG. 3 shows that a coordinate system “oxy” is established, wherein the origin “o” is an intersecting point of the optical axis O and a widthwise direction of the planar waveguide 130, “x” axis is the widthwise direction of the planar waveguide 130, and “y” axis is a phase shift of the laser beam 20 at a point “x”. According to wave theory of planar waveguides, j=a(1−e^{kx}^{²}, wherein x>0 , a , e and k are constants. In this embodiment, boundaries of the media strips 131 are set to conform to conditions of formulae: yₙ=a(1−e^{k}^{ₙ}²) and yₙ=nπ, wherein xₙ is the nth boundary of the media strips 131 along the “x” axis, and yₙ is the corresponding phase shift. That is,

$${x}_{n} = \sqrt{\frac{ln ( 1 - \frac{n π}{a} )}{k}} ( {x}_{n} > 0 ) .$$

The boundaries of the media strips 131 where xₙ<0 can be determined by characteristics of symmetry of the media grating 130.

The first electrodes 140 are formed by coating a layer of copper on the planar waveguide 120. A length and height of the first electrodes 140 are equal to or larger than a length and height of the media grating 130, respectively.

The waveguide 150 is formed by infusing titanium into the substrate 110.

The second electrodes 160 are formed by coating a layer of copper on the substrate 110. The second electrodes 160 are longer than or as long as the second branch 153. In this embodiment, the second electrodes 160 are as long as the second branch 153.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. An electro-optic modulator, comprising:
a substrate;
a planar waveguide formed in the substrate, the planar waveguide comprising a sidewall to receive a laser beam traversing along an optical axis and an interface opposite to the sidewall;
a media grating loaded on the planar waveguide, the media grating and the planar waveguide constituting a waveguide lens to converge the laser beam;
a pair of first electrode positioned on the planar waveguide to modulate an output of the waveguide lens by changing a refractive index of the planar waveguide;
a waveguide formed in the substrate and comprising an input section connecting the interface to receive the laser beam, the waveguide further comprising a first branch and a second branch both extending from the input section; and
a pair of second electrodes positioned on the substrate and located at two opposite sides of the second branch, the second electrodes being configured to modulate an output of the first branch by changing refractive indexes of the first branch and the second branch.

2. The modulator of claim 1, wherein the substrate is made of lithium niobate crystal.

3. The modulator of claim 1, wherein the planar waveguide is made of lithium niobate diffused with titanium.

4. The modulator of claim 1, wherein the media grating is made of lithium niobate diffused with titanium.

5. The modulator of claim 1, wherein the media grating is a chirped grating.

6. The modulator of claim 1, wherein the media grating comprises an odd number of media strips extending along a direction that is substantially parallel with the optical axis, each of the media strips is rectangular, in this order from the optical axis to each side of the media grating, widths of the media strips decrease, and widths of gaps between each two adjacent media strips also decrease.

7. The modulator of claim 6, wherein a coordinate axis “ox ” is established, wherein the origin “o ” is an intersecting point of the optical axis and a widthwise direction of the planar waveguide, and “x” axis is the widthwise direction of the planar waveguide, boundaries of the media strips are set to conform condition formulae:
$${x}_{n} = \sqrt{\frac{ln ( 1 - \frac{n π}{a} )}{k}} ,$$
and xₙ>0, wherein xₙ is the nth boundary of the media strips along the “x” axis, and a and k are constants.

8. The modulator of claim 1, wherein a length and height of the first electrodes are equal to or larger than a length and height of the media grating, respectively.

9. The modulator of claim 1, wherein the waveguide is made of lithium niobate crystal diffused with titanium.

10. The modulator of claim 1, wherein the second electrodes are longer than or as long as the second branch.
